(19) United States
(12) Patent Application Publication
(10) Pub. No.: US 2013/0310717 A1
(43) Pub. Date: Nov. 21, 2013

(54) CUSTOMIZED, MECHANICALLY-ASSISTIVE REHABILITATION APPARATUS AND METHOD FOR DISTAL EXTREMITIES OF THE UPPER AND LOWER REGIONS

(71) Applicant: NORTHEASTERN UNIVERSITY, Boston, MA (US)

(72) Inventors: Richard RANKY, Ridgewood, NJ (US); Craig PACELLA, Norwell, MA (US); Nisha PAREKH, Boston, MA (US); Abnishek SINGHAL, Boston, MA (US); Aaron BICKEL, Allston, MA (US); Constantinos MAVROIDIS, Arlington, MA (US)

(73) Assignee: NORTHEASTERN UNIVERSITY, Boston, MA (US)

(21) Appl. No.: 13/705,982

(22) Filed: Dec. 5, 2012

Related U.S. Application Data
(60) Provisional application No. 61/566,737, filed on Dec. 5, 2011.

(51) Int. Cl. A61H 1/02

(52) U.S. Cl. CPC A61H 1/0288; A61H 1/0266
USPC 601/40

(57) ABSTRACT

An apparatus for distal extremity rehabilitation includes a mechanical ground subassembly for disposition on a dorsal side of a patient's distal extremity, at or near a joint of the patient. The distal extremity may include the hand/wrist complex or the ankle/foot complex. The mechanical ground assembly may be constructed to match contours of the patient's distal extremity. The apparatus further includes a distal effector subassembly for disposition upon one or more distal appendages of the patient, the distal effector subassembly coupled to the mechanical ground subassembly. The apparatus also includes an LED thimble subassembly for disposition on one or more finger tips of the patient, and an LED object subassembly with which the patient interacts by manipulating the LED thimble with respect to the LED object.

### CROSS REFERENCE TO RELATED APPLICATIONS

This application claims benefit of the following Patent Application, the contents of which are hereby incorporated by reference in their entirety: U.S. Provisional Patent Application Ser. No. 61/566,737, filed Dec. 5, 2011.

### BACKGROUND

Stroke is a leading cause of chronic adult disability. Parts of the brain that are responsible for regulating movement are in many cases damaged by the stroke.

Rehabilitation, however, can be undertaken to help a stroke patient regain at least some motor function. These rehabilitation exercises typically take the shape of repetition of desired motion, which rewires the brain to allow other undamaged portions of the brain to be used for the desired functions. This process is known as brain plasticity. The rehabilitation exercises traditionally employed physical contact with a therapist and various low-tech objects that resist motion to strengthen weak muscles.

Robotic and assistive systems are increasingly being used in clinical settings for rehabilitation. These systems offer advantages such as precise feedback and quantitative data analysis, adaptability to various situations, and a computer interface to make the repetitive motion more interesting for the patient. Numerous studies have shown that device and robot-assisted rehabilitation is more effective than traditional methods of stroke rehabilitation, and results in a quicker and more thorough recovery.

A goal for disabled post-stroke patients as exemplary activities for the upper extremities is to be able to perform Activities of Daily Living (ADL) such as buttoning a shirt, turning a doorknob to open a door, being able to write with a pencil, and so on. Regaining the ability to engage in ADL is very important to stroke patients and requires rehabilitation of both gross and fine motor function. Unfortunately, this is the area that is most difficult to rehabilitate effectively with robotic technology. Literature on robot-assisted upper extremity rehabilitation indicates that while robotic rehabilitation is significantly more effective than traditional rehabilitation in helping patients regain gross motor function, it is not statistically superior in assisting with recovery of ADL. The fact that they do not indicates an opportunity to improve the existing robotic technology with an eye toward ADL rehabilitation.

A possible shortcoming of all the current commercially available upper-extremity stroke rehabilitation devices is lack of focus on the distal extremities such as the under-developed hand/wrist interface and the ankle-foot complex. The upper extremity interface is familiar in both of the widely-used commercial robotic systems, the IMT InMotion and the Hocoma Armeo, as consisting of a grip cylinder that can be manipulated only in a single configuration like a joystick. This interface cannot offer dexterous motion of the fingers and thus cannot work to rehabilitate the motions of most of these ADL activities. As many ADLs depend on manipulation of the extremities such as fingers and hand or toes and feet, it could be beneficial to create a device that will allow these motions to be rehabilitated as well and that will interface with the proven functionality of the existing robotic systems. If the proven benefits of robotic stroke rehabilitation can be extended to a device that allows a greater range of fine motion, stroke patients could benefit from the same improved outcomes and recoveries that are seen with gross motion robotic rehabilitation.

Furthermore, while it is currently commonplace to attempt to rehabilitate fine movement and gross movement separately for the extremities, which allows for use of a robotic system for the gross motion and then other, low-tech methods such as putty balls for fine motion, there is some evidence that patients benefit from simultaneous rehabilitation of the hand, fingers, and arm. Indeed, many ADLs, such as turning a doorknob or a key, or fitting on a sock require coordinated, simultaneous fine motion and gross motion. It is not currently possible to do this simultaneous rehabilitation with robotic assistance because the current robotic systems do not allow for dexterous finger movement. Thus, adding a distal extremity interface that can be used in concert with the existing robotic systems has the potential not just to allow the benefits of robotic assistance in another mode of therapy, but to offer a combined mode of therapy that may yield better results than either therapeutic mode can yield on its own.

One reason why existing robotic rehabilitation devices may not include fine dexterous motion is that such motion is complex and highly variable, depending both on what motion is desired and on the specific anatomy and impairment of a patient. Such a complex system would be difficult to produce in a “one-size-fits-all” manner while maintaining universal effectiveness. A custom device fit for specific users, impairments, and ranges of motion could avoid the problem of variability, thereby providing a specific solution for each patient.

### SUMMARY OF THE INVENTION

The described embodiments include devices related to rehabilitation of upper and lower distal extremities. In some embodiments, the devices relate to wearable rehabilitation. As used herein, “wearable” means that the device can be worn on a person's body or wrapped in some way around some portion of a person's body. “Rehabilitation” means that the device can provide forces that through repetitions will correct a person's anatomical posture. Further, some or all of the surfaces of the device in contact with the human body may be customized, through 3D scanning (or other characterizing technique) to the patient's anatomy for increased comfort.

In some embodiments, the neutral position of the device may be different than the patient's body part neutral position which means that the device tends to “drive” the patient to a neutral position that is considered to be normal.

In some embodiments, the device may have a mechanical ground piece that supports all other pieces (in the exemplary upper extremity case, this is the MCP assembly). The device may also have a series of articulations and links that correspond to the human body's joints and bone structures. The mechanical ground may constructed according to a patient or wearer's anatomy (anatomically-based mechanical ground; AMG).

In some embodiments, the device may have been fabricated using 3D printing so that it is low cost, customized, light weight and can combine multi-material parts for variable stiffness.

In some embodiments, the device may have embedded electronic components such as force sensors to measure position, velocity, and force of various portions of the device. The device may have embedded or built in during fabrication spring elements that can apply corrective forces. The device may be interfaced with objects that contain LEDs to motivate the patient perform certain tasks. In some embodiments, the device may be interfaced wirelessly with a computer for data collection, analysis and game interfacing.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 shows an Armeo system.

FIG. 2 shows an InMotion system.

FIG. 3 shows one embodiment of a rehabilitation device.

FIG. 4 shows another embodiment of a rehabilitation device.

FIG. 5 shows an exemplary mechanical anchor.

FIG. 6 shows an exemplary mechanical anchor worn by a patient.

FIG. 7 illustrates components of an exemplary distal effector.

FIG. 8 illustrates a component of the distal effectors shown in FIG. 7.

FIG. 9 illustrates one embodiment of a rehabilitation device.

FIGS. 10A and 10B illustrate an embodiment of a rehabilitation device.

FIG. 11 illustrates an embodiment of a rehabilitation device.

FIGS. 12A and 12B illustrate an LED thimble subassembly.

FIG. 13 illustrates one embodiment of an LED object.

FIG. 14 illustrates another embodiment of an LED object.

FIG. 15A and 15B illustrate an exemplary design for an LED housing component.

FIG. 16 illustrates parameters used for construction of the distal effector.

FIG. 17 illustrates one embodiment of a full set of DIP and PIP finger links, for all four fingers of one hand.

FIG. 18 shows an example of four bend sensors used in the described embodiments.

FIG. 19 shows the finished assembly of a rehabilitation device on the hand of a patient.

FIG. 20 illustrates another embodiment of the rehabilitation device.

FIG. 21 illustrates an exemplary computer system for use with the described embodiments of a rehabilitation device.

### DETAILED DESCRIPTION

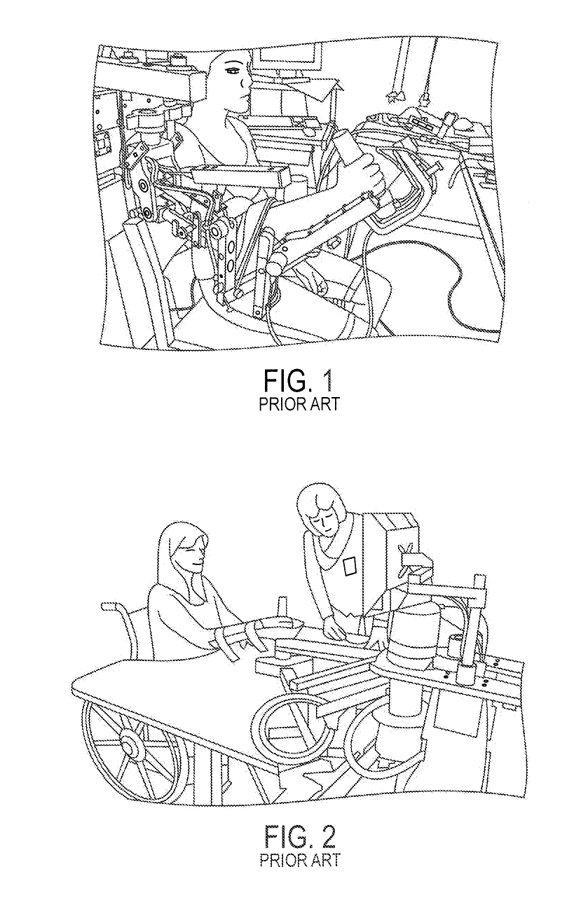

The described embodiments of the invention include a method and apparatus for facilitating the recovery of one or more distal extremities (e.g., hand, wrist and finger motion). The described embodiments may interface with existing rehabilitation systems. For example, exemplary rehabilitation systems for interfacing with the described exemplary upper extremitiy embodiments are the Armeo (FIG. 1), made by Hocoma AG, and the InMotion (FIG. 2), made by Interactive Motion Technologies, Inc. (IMT). While described exemplary embodiments for interfacing with the described lower extremities are the Rutgers ankle and the NUVABAT.

These exemplary systems have similar hand/wrist and ankle/foot interfaces that include a simplified target object, with no opportunity for independent dexterous movement of the fingers or toes. While the described embodiments focus on an apparatus that can interface with such devices, the same concepts could be adapted to the InMotion as well and extend the same benefit to that system. Further, the described embodiments may be adapted to interface with other rehabilitation systems in addition to Armeo and Rutgers Ankle.

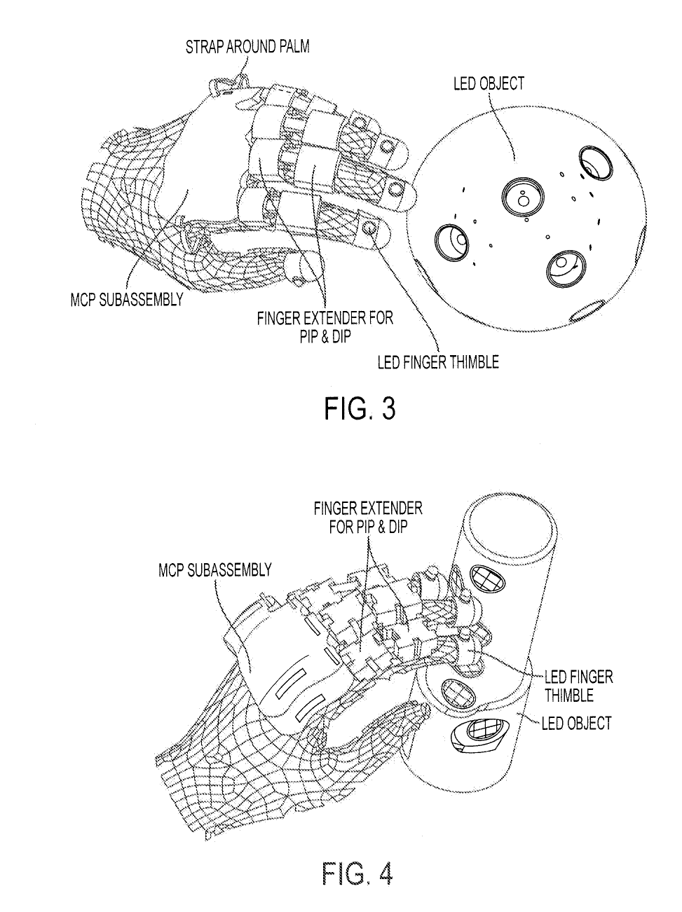

FIG. 3 illustrates one embodiment of the invention. FIG. 4 illustrates another embodiment of the invention. Each of these embodiments of an exemplary upper extremity rehabilitation device includes one or more of (1) an anatomically-based mechanical ground subassembly, (2) distal effector subassemblies, (3) LED distal effector thimble subassemblies, and (4) LED Object Subassemblies.

### (1) Anatomically-based Mechanical Ground (AMG) Subassembly

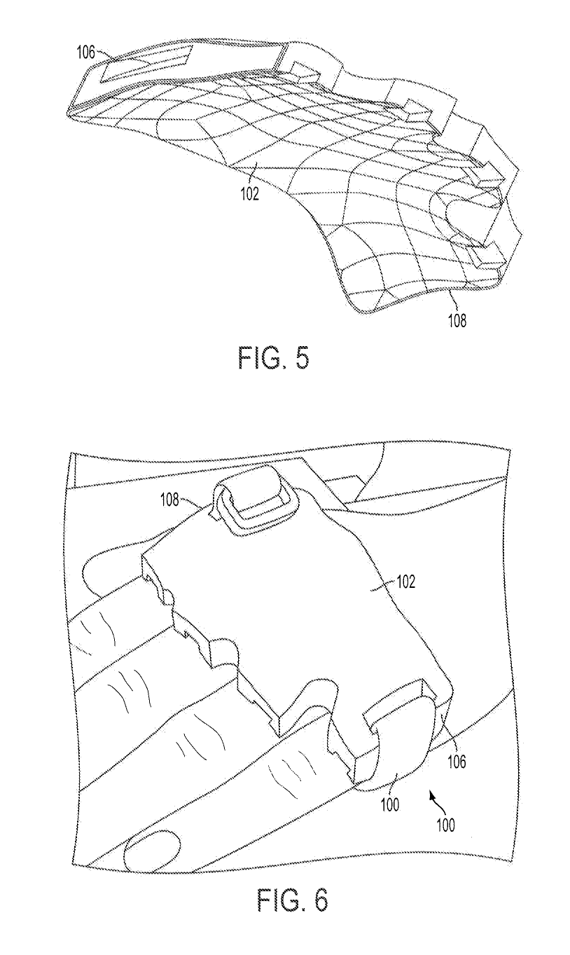

One purpose of the AMG Subassembly is to prevent hyperextension of critical bone complexes by stabilizing their positions during exercises, such as the MCP (metacarpophalangeal) joint during finger extensions for upper extremity exercises and the medial and lateral malleoli for ankle range of motion exercises. In the described upper extremity embodiment, the AMG Subassembly is shown as an MCP Subassembly 100. In this embodiment, the MCP Subassembly 100 clamps the patient's hand between a dorsal side component 102 (as shown in FIG. 5) and a strap 104 connected to a first portion 106 and a second portion 108 of the dorsal side component 100 to demonstrate application for mechanical grounding adjacent to the fingers. FIG. 6 illustrates one embodiment of the MCP Subassembly in place on a patient. In the exemplary upper extremity embodiment, the dorsal side component 102 of the MCP Subassembly is a hard plastic material. The elastic strap 104 that stretches from the two portions 106, 108 over the patient's palm is an elastic fabric material. A Velcro material is attached to the elastic fabric for securing the MCP Subassembly to the wearer.

The dorsal side component 102 of MCP Subassembly 100 (i.e., the side in contact with the patient hand) may be customized to the patient by 3D scanning the patient's extremity such as hand or ankle, and producing the dorsal side component 102 using additive manufacturing techniques with the scan data as input. Doing so matches the dorsal side component 102 to the contours of the patient's hand. While the exemplary embodiments use scanning data and additive manufacturing to customize the MCP subassembly to the contours of the patient's hand (or potentially ankle-foot complex), other embodiments may use other techniques to approximate the patient's physical characteristics and to produce the AMG Subassembly suitable for the patient's use.

For the described embodiments, the 3D scan of the patient's distal appendage is used as the basis to design a custom Anatomically-Based Mechanical Ground Subassembly, such as an MCP subsystem on a computer aided design (CAD) system. The CAD file of the MCP subsystem is sent to an additive fabrication system such as stereolithography (SLA) machine (3D Systems Viper), or fused deposition system (Stratasys), or Selective laser Sintering System (EOS), where the MCP subsystem is fabricated layer by layer.

Once all of the layers are deposited, the material is left to cure and dry so all excess liquid is removed from the fabricated subsystem. Finally, the support material is removed leaving only the AMG subsystem structure. The additive fabrication system places parts on an inclined rack to allow excess material to evacuate, after which the parts are post-processed (e.g., cured in a UV oven) with a technique appropriate to the selected fabrication material.

In one embodiment, the elastic strap that fastens the AMG Subassembly to the body is a hook and loop arrangement strap that is be flexible and stretchable to provide a comfortable interface to the patient, although other known techniques for temporarily and removably attaching a rehabilitation apparatus to a patient may also be used.

### (2) Distal Effector Subassembly

The distal effectors assist the patient to open his or her fingers, hand or toes from the resting position (which in the case of someone post-stroke tends to be contracted compared to a healthy neutral position), to a state in which the fingers, hands or toes are almost straight (i.e., fully extended). Based on the specific patient's spasticity and extent of stroke, each patient may have a different resting position. The finger, wrist, ankle extenders are also designed in such way that the dorsal side of the distal effectors were kept clear. Body parts such as fingers, hands and toes are referred to herein as distal extremities, distal appendages or just extremities or appendages.

Although mold and casting methods are applicable to generate the Distal Effector Subassembly, some embodiments may also be based on a 3D scan of the patient's distal extremity for a more precise fit. Even without 3D scanning, the distal effector subassemblies of the described embodiments are still customized for each user, and thus are fabricated using additive manufacturing.

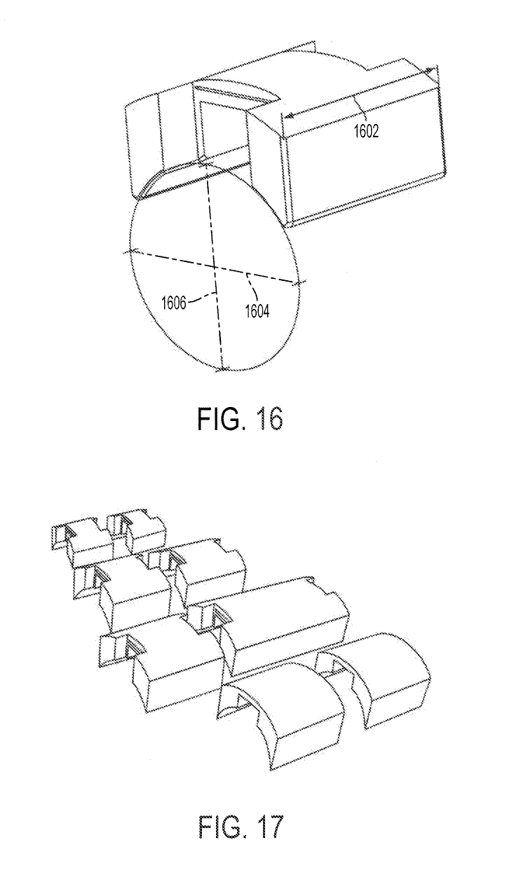

In an upper extremity embodiment, the distal effector subassemblies are designed in Computer-Aided Design (CAD) software as a single part with eight digital extremity configurations, corresponding to the MCP-PIP link and the PIP-DIP link (referred to generally as distal effector links), each for index, middle, ring, and pinky finger. The eight configurations have differing geometry in three different parameters: length 1602, width 1604, and height 1606; this can be seen in FIG. 16. These parameters can be measured on the patient's hand using calipers recorded for each patient. The CAD system may then automatically populate the digital extremity configurations with dimension values from the recorded data, automatically generating parts that fit the patient.

The resting position can be enforced with the help of springs that allow compression force at the AMG joint and compression forces at the most proximal joint. For feedback to the physical therapist (PT) and the patient, a bend sensor is also embedded into distal extremity extenders. The particular values of compression force and neutral position are examples only and may vary from patient to patient.

While other embodiments may include separate, fully adjustable torsion or linear springs at each joint in order to assist in the extension of the patient's extremities, the described embodiments utilize a single leaf-type spring in each extender to assist with the motion. The leaf spring is designed so that the spring's neutral (straight) position roughly matches the desired fully extended position of the extremity due to the forces applied by the springs. Thus, it will assist motion without overcoming the patient's natural motion, giving the patient freedom to close the hand, or open it further. A variation on the modularity of the design has interchangeable springs that can be added in as needed depending on the force required.

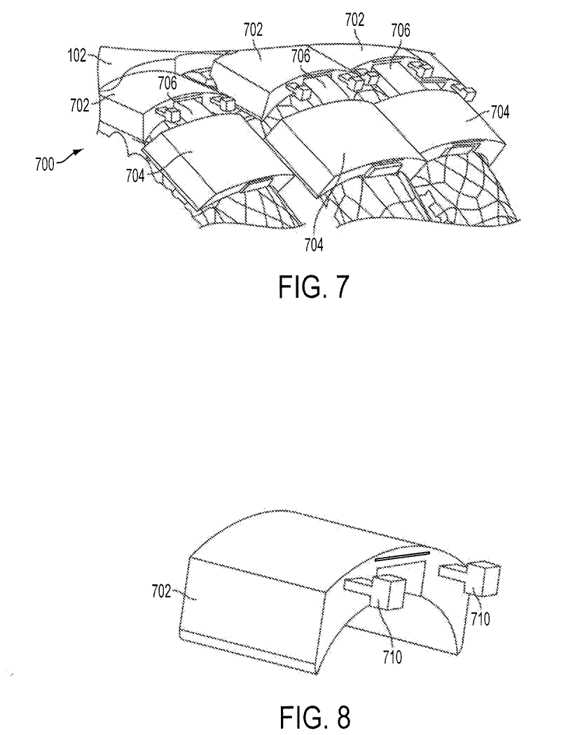

The described upper extremity embodiments of the distal effector subassembly 700 incorporate three distinct components—a PIP finger link 702, a DIP finger link 704 and a flexible link 706—all coupled together to form a cooperative finger extender unit. It should be understood, however, that for other embodiments associated with different extremities, additive manufacturing tools with capabilities to print heterogeneous parts may be used to produce a one-piece design of the distal effectors. In the described embodiments, the joints of the fingers have separate rigid pieces which are joined by a flexible link that fits onto the finger with comfort and acts as a spring. FIG. 7 and FIG. 8 illustrate these components.

The material used to fabricate the flexible link 706 may be different from patient to patient. Certain types of materials, e.g., Delrin acetal resin, polypropylene, and nylon (all of which can be cut into various widths) each exhibit different characteristics regarding comfort, difficulty in bending and amount of assistance the material provides in opening the finger. In some embodiments, a particular patient may be tested with various materials and widths of those materials to determine the most suitable material/width for the flexible link 706.

The PIP finger link 702 may include one or more protrusions 708 that cooperate with the DIP finger link 704 to prevent (or at least reduce) hyperextension of the DIP joint. The configuration of the exemplary protrusions 708 shown in FIG. 8 may be different in other embodiments. The PIP finger link 702 may also include a slot 710 for accommodating a thin film band sensor or other suitable sensor component.

The flexible material of the flexible link 706 may, in some embodiments, be chosen to be similar to the material used to construct the other components of the distal effector. That flexible material acts as the connector for the distal effector links and also performs the function of a spring.

In some embodiments, the AMG subassembly and the distal effectors are integrated (i.e., constructed as a single piece). With additive manufacturing, the entire piece can be created at once, reducing the complexity and assembly time of the device. A single piece device should be rigid at the dorsal side of the extremity behind the AMG and on the dorsal side of the extremity between the joints and the effectors, to prevent any hyperextension. It also should be flexible at the MCP and PIP to allow bending, and it should act as a spring to open the joints for the wearer. Such requirements lead to different material properties at different portions of the same part.

One way to accomplish different material properties at different portions of the same part is to manufacture the part using Objet multi-polymer jetting technology, which allows additively manufactured parts made of multiple materials. The +multi-polymer jetting technology would allow for different portions of the device to have different material behaviors.

In another embodiment, the AMG subassembly and finger extender subassemblies are manufactured as a single unit, using a relatively flexible material and use different material thicknesses to achieve desired behavior. The material is thick where no flexing is desired and thin out around joints, with thick rigid blocks in place to prevent hyperextension. One such exemplary stereolithography material (Accura 25), mimics the properties of flexible polypropylene.

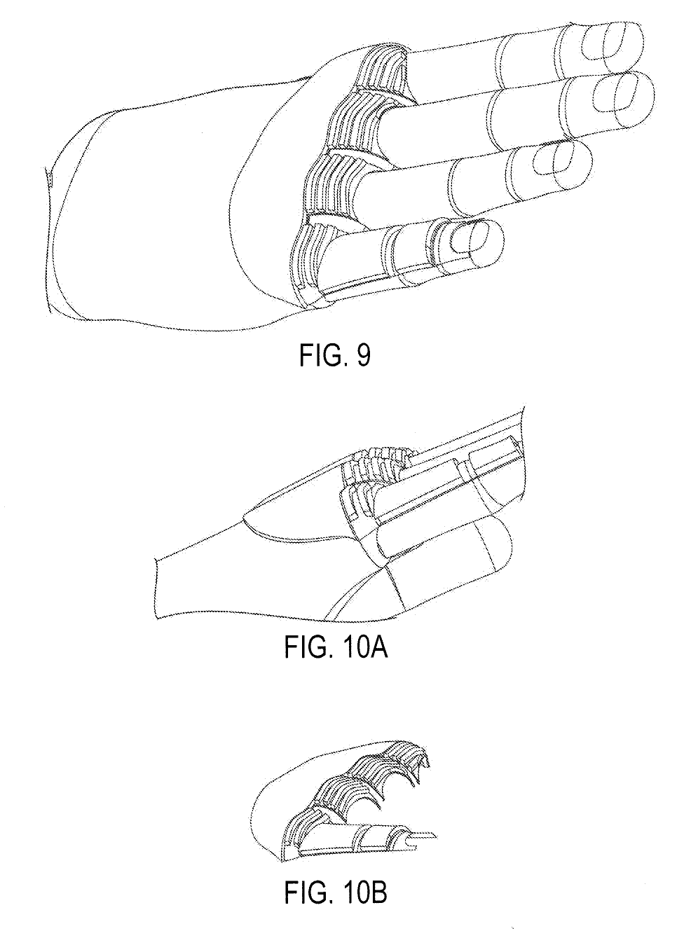

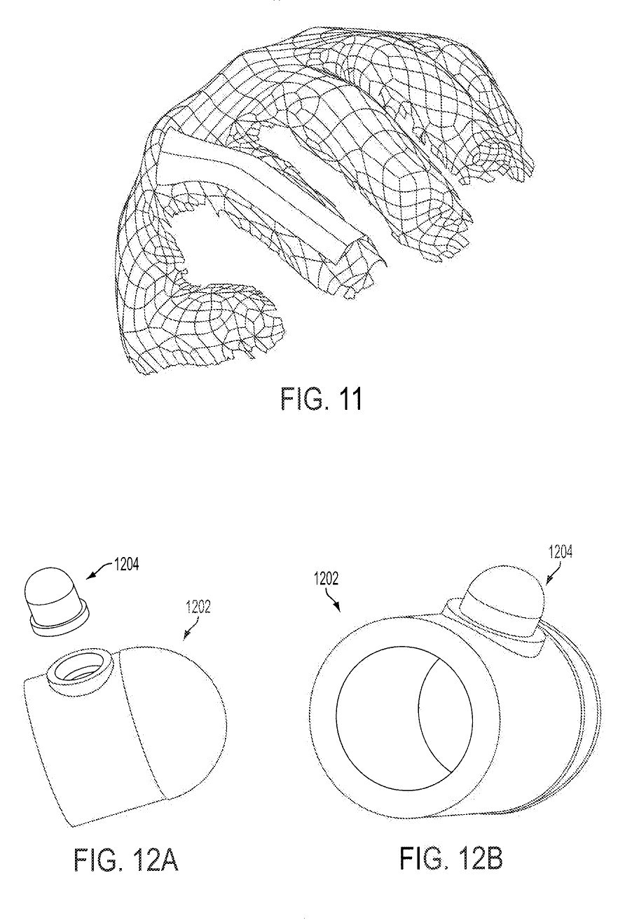

FIG. 9, FIG. 10A, FIG. 10B and FIG. 11 illustrate another embodiment of an integrated AMG subassembly as a MCP subassembly 100 and distal effector subassembly 700 unit.

FIG. 17 illustrates one embodiment of a full set of DIP and PIP finger links, for all four fingers of one hand.

### (3) LED Distal Effector Thimble Subassembly

The LED distal effector thimbles 1202, illustrated in FIG. 12A and FIG. 12B, are the “eyes” of the device—they give the patient the ability to interact with the LED object (described in detail below).

In one embodiment, the thimble is constructed from a wearable silicon material capable of housing RGB (Red-Green-Blue) LED 1204. It should be understood that reference herein to a “RGB LED” is an exemplary reference only, and that the LED may be any type of LED or other light-producing component. The thimbles are electrically connected to or through the AMG subassembly and the distal effector subassemblies, and are placed on the patient's distal extremities, such as fingertips or toes. Each extremity is assigned a thimble with a different colored LED.

During use, the patient is instructed to match the color of the LED on each effector with the color of the LED on the LED object. This is the proposed exercise and function of the device.

In one embodiment, the LED thimbles are constructed of silicon, manufactured using a two-piece mold created via additive manufacturing. The elastic silicon material will fit snugly over the distal extremity with an RGB LED embedded thereon. The tip of the thimble is covered with a conductive film, attached to the thimble with conductive adhesive. The conductive film is electrically coupled to an electrode, and the electrode is electrically connected through the distal effector and/or AMG subassembly to a data acquisition system. This arrangement allows for determining when the patient touches a given external location, that has an electrical charge or is maintained at a particular potential with respect to a reference, with a given distal extremity.

While the described embodiments utilize a conductive film on the tip of the thimble, other conductors may also be used. For example, in some embodiments one or more conductive strips or bands may be secured to the thimble tip. Similarly, one or more conductive wires may be wrapped about the tip of the thimble in other embodiments. In some embodiments, the thimble tip itself may be fabricated from a conductive material.

The data acquisition system may be part of a computer interface for the rehabilitation device. The computer allows for customizable programs to receive information from, and to drive signals to, the LEDs for a rehabilitation protocol suitable for a user with a specific condition.

### (4) LED Object Subassembly

The LED object provides a target or objective with which the patient can interact. In one embodiment, the LED object houses one or more RGB LEDs, although for other embodiments different light sources may be used. The driving source of these LEDs may be programmed to execute a game in which the patient participates.

The RGB LED may be customizable to any shape and size and may be made using additive manufacturing techniques. Considering the gaming nature of this phase, a feedback mechanism may be incorporated to tell the user if he/she is touching the correct target LED with the correct finger, wrist motion or toe.

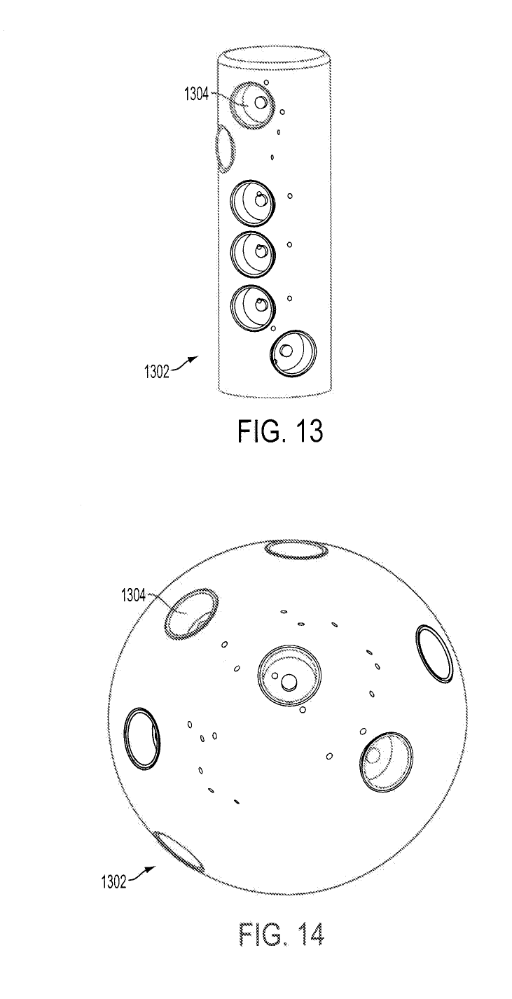

The LED objects in one embodiment feature a standardized housing along with the electronics required to support the LED operation. Since the housing has a standardized architecture, it may be interchanged between other objects. An object can then be designed and built via additive manufacturing in any shape and with any configuration of LEDs, according to the wishes of the physical therapist. The shape will just have to have holes for the standardized housing geometry and a hollow interior to fit any required electronics. For exemplary embodiments, the LED objects include a cylinder, with 6 LEDs, and a sphere, with 9 LEDs, as shown in FIG. 13 and FIG. 14, respectively. In other embodiments, objects with alternative geometries can be created using the same process described herein.

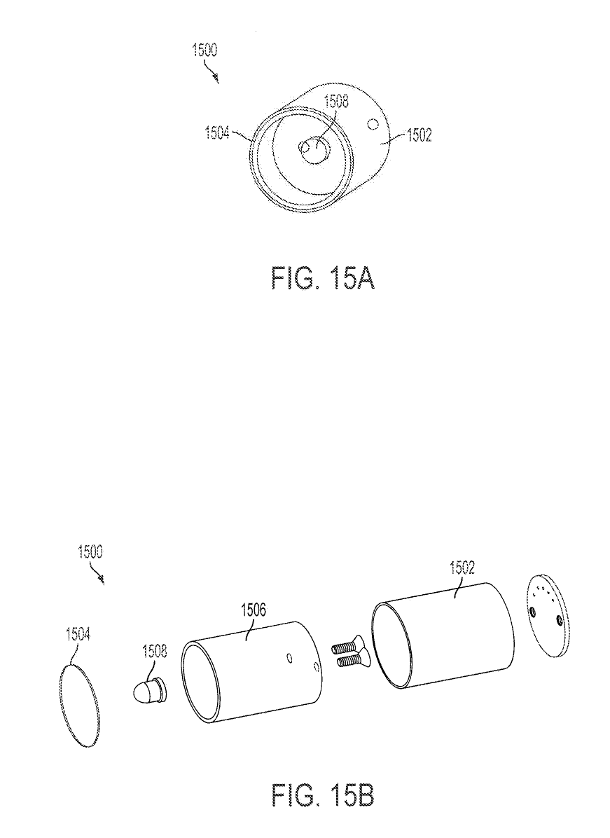

The exemplary design for the LED housing component 1500 shown in FIGS. 15A and 15B. The housing fits into pre-manufactured holes in the LED object with the help of a silicon cover 1502. The transparent conductive film 1504 at the top of the housing 1500 serves as the feedback mechanism for the patient as every time the patient contacts the LED to match the color on the LED thimble a program will take into account the action performed by the user, using the conductive film to cross check if the input is true or false. The housing shell 1506 is a metallic cylindrical piece with a surface to hold in the RGB LED 1508 and some open space for support circuitry.

In other embodiments, the conductive film 1504 may be replaced with a conductive mesh material, e.g., copper wire mesh. In general, any material that (i) is electrically conductive and (ii) allows light to pass through can be used for the conductive film 1504.

An electrically conductive path is provided from the conductive film 1504 to the base of the LED housing, so that a charge coupled to the conductive film 1504 can be relayed to the LED object for detection and/or measurement. In one embodiment a wire or other conductor is provided within or outside of the LED housing shell. In other embodiments, the housing shell may be constructed from an electrically conductive material so that the shell itself provides the conductive path.

The LED object may also include a computer interface for the rehabilitation device. The computer allows for customizable programs to receive information from, and to drive signals to, the LED object for a rehabilitation protocol suitable for a user with a specific condition.

### Customizability

In order to customize the distal extremity rehabilitation device, one or more embodiments utilize a 3D scanner to capture surface topology information associated with the patient's distal extremity.

The patient's extremity is scanned using, for example, a Vivid 9i scanner (made by Konica Minolta). After acquiring the scan data, the data is cleaned and prepared using a software package such as Rapidform XOR in order to get rid of external or other surfaces that might have been captured during the scanning process and also to make the scan more accurate.

Following the cleaning and surface preparation, the data is imported into Solidworks modeling software where the components described above can be designed to fit the patient's dimensions using the scanned surface information.

This customization is more important for some of the subassemblies than others. Customization is most important for the AMG subassembly as it is the part of the rehabilitation device that will prevent hyperextension of the MCP joint and also serves as the device's primary anchor surface to the extremity. The anatomy of this area differs significantly from patient to patient. In order for the device to fit correctly and comfortably and work effectively, accurate and precise dimensions of the patient's distal extremity must be accounted for using the 3D scan process.

Customization is somewhat less important for the distal effector subassembly. In the described embodiments, the finger extenders are not required to be customized to the user's extremities with the 3D scan process since one or two less precise measurements of the fingers or foot can be used to construct the part to fit the user's hand or foot. The length between the various joints are all the parameters that need to be used to construct the distal effectors. Since this part will house the bend sensors and provide feedback to the physical therapist based on the amount of pressure the user inserts on the distal effectors to open their fingers, springs that will be removable and adjustable will be incorporated into the design to offer extensive adjustability to make the distal effectors functional.

In the described embodiments the LED thimbles are standard and not customizable because designing the LED thimble to be custom fit to the user is time intensive. Further, since the variation in sizes of distal extremities is typically not too large, it is smarter and faster to simply make standard sizes.

It should be understood that in other embodiments, any or all of the rehabilitation device components can be customized through 3D scanning. In some embodiments on the other hand, the characteristics of the rehabilitation components may all be determined without the benefit of 3D scanning.

The LED object may also be customizable. For example, the physical therapist may develop a unique exercise protocol for a particular patient, and may specify any kind of object shape and positioning of the LED holes necessary for execution of the exercise protocol.

### Final Assembly of Rehabilitation Device

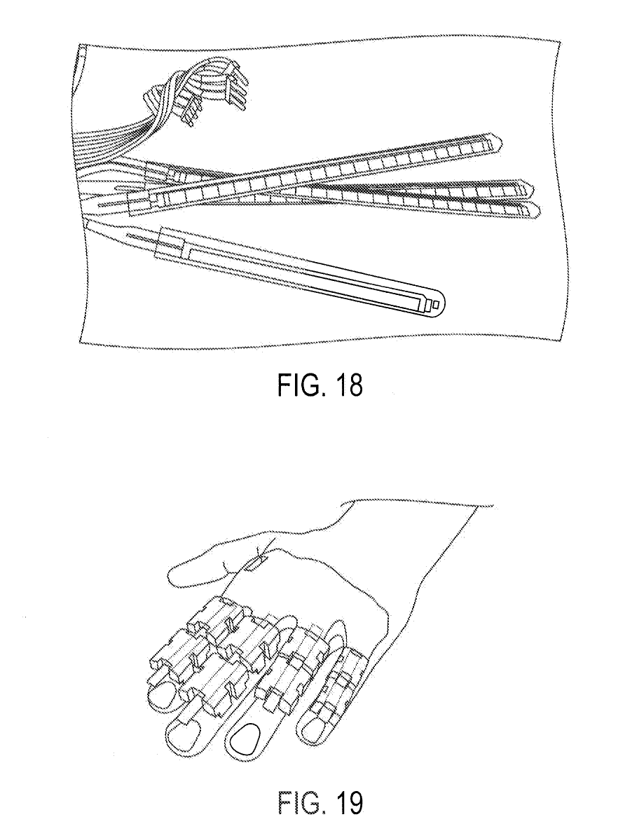

Once the AMG subassembly is assembled as shown in the exemplary MCP clamp of FIG. 6. The eight finger extender links (as shown in FIG. 17) are organized according to what finger section each was produced for. The two index finger links are then attached to a leaf spring, and the same is done for the middle, ring, and pinky fingers. In one embodiment, a strap of thin elastic nylon may be adhered to each distal effector to keep them on the patient's fingers. In other embodiments, an O-ring or elastic fitting may be used to hold the finger links in place. Each of these four finger extender subassemblies has a thin film bend sensor inserted through the bend sensor slot. FIG. 18 shows an example of four bend sensors used in the described embodiments.

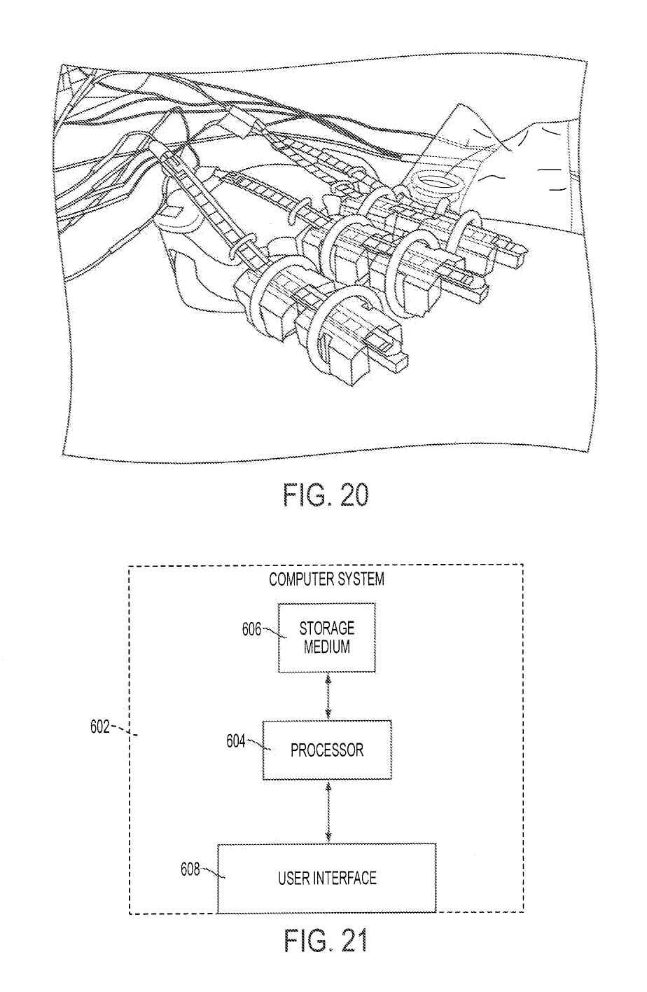

The leaf spring from each finger extender subassembly is connected to the MCP subassembly, joining the five assemblies into one. In the described embodiments, the joining of the MCP subassembly to the leaf springs, as well as the joining of the leaf springs to the finger links, is accomplished using UV-cure resin. In other embodiments, a two-part epoxy (e.g., Huntsman 2012 Araldite) or other adhesive may be used. The resin was injected in and around the contact areas and then the assembly was cured in a UV oven for one hour, causing the resin to harden. FIG. 19 shows the finished assembly on the hand of a patient. FIG. 20 illustrates another embodiment of the rehabilitation device, after painting. The bend sensors, the MCP strap, and O-rings to retain fingers are all installed.

### Use Of The Rehabilitation Device

The modes described below are examples of how the described embodiments may be used to rehabilitate a stroke patient to regain some or all of the use of their upper extremities.

### Mode 1: Distal Effector Flexion and Extension

The patient places the device of the described embodiments on his or her hand, wrist or foot with help from the physical therapist. Springs are inserted in each distal effector as required. Springs open to healthy neutral positions of the extremities. The patient may then exert force to further open one or more of their upper or lower extremities. Once they are opened, the springs will again cause the fingers, wrists or toes to flex to the neutral position. The patient can then attempt to close the extremity against the spring force and/or they can attempt to re-extend the extremities, according to the physical therapist's instructions. With this assistance in opening the extremity to a neutral position, the therapist may also have the patient use the LED objects (see mode 2).

The physical therapist will get feedback from the computer with analog measurements of total bend angle across the MCP and PIP as well as total force exerted against the springs, with respect to time.

### Mode 2: LED Object Game

The patient puts on device of the described embodiments (see Mode 1) with help from the physical therapist. Springs can be removed if they are making the LED game too difficult, assuming removable springs are fitted to the device, or they can be kept in to assist in extending the fingers and so as to get bend angle and force measurement during the LED game. The LED object is put on a desktop or attached to the Hocoma Armeo system or similar wrist/hand or ankle/foot rehabilitation system. The physical therapist selects LED game mode from computer interface and selects an existing program for the LED object. A colored LED or combination of colored LEDs lights up on the object, and a colored LED or combination of colored LEDs lights up on the patient's fingers. Every time the patient touches every lit up LED on the object with correspondingly-colored finger, it registers as a success and a new sequence of LEDs light up.

Embodiments described herein can be implemented in association with various types of computer systems (e.g., desktop, laptop or notebook PC, mobile handheld computing system, workstation or other particular machine). Described embodiments may be implemented in a computer program product that may be non-transitory and may be tangibly embodied in a machine-readable storage medium for execution by the computer system. Methods of described embodiments may be performed by a computer system executing a program to perform functions, described herein, by for example, operating on input data and/or generating output.

An exemplary computer system 602 is shown in FIG. 21. Referring to FIG. 21, computer system 602 may include a processor 604, an information storage medium 606, and a user interface 608. These components may be contained within a typical desktop, laptop or mobile form factor housing, or they may be integrated into a single component such as a multi-chip module or ASIC (application specific integrated circuit).

Suitable processors 604 may include, for example, both general and special purpose microprocessors. Generally, the processor 604 receives instructions and data from a read-only memory (ROM) and/or a random access memory (RAM) through a CPU bus. The processor 604 may also receive programs and data from a storage medium 606, such as, for example, an internal disk operating through a mass storage interface, or a removable disk operating through an I/O interface. Instructions for executing the described embodiments may be stored on the storage medium.

Information storage media 606 suitable for tangibly embodying computer program instructions for implementing the described embodiments may include various forms of volatile memory and/or non-volatile memory, including but not limited to, semiconductor memory devices, such as EPROM, EEPROM, and flash memory devices, and magnetic disks, such as internal hard disks and removable disks, magneto-optical disks, and CD-ROM disks. The information storage medium 606 may also store an operating system (“OS”), such as Windows or Linux, which the processor may execute to provide, for example, a supervisory working environment for the user to execute and control, for example, one or more embodiments of the invention.

The user interface 608 may include a keyboard, mouse, stylus, microphone, trackball, touch-sensitive screen, or other input device. These elements are typically found in a conventional desktop computer as well as other computers and workstations suitable for executing computer programs implementing methods described herein. The computer system 602 may also be used in conjunction with a display device for providing a GUI. The display device may include an output device that may be capable of producing color or gray scale pixels on paper, film, display screen, or other output medium.

The computer system may also interface to electrical components within the described embodiments of the rehabilitation device, including but not limited to the LEDs and the sensor components.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. An apparatus for distal extremity rehabilitation, comprising:
a mechanical ground subassembly for disposition on a dorsal side of a patient's distal extremity, at or near a joint of the patient;
a distal effector subassembly for disposition upon one or more distal appendages of the patient, the distal effector subassembly coupled to the mechanical ground subassembly;
an LED thimble subassembly for disposition on one or more finger tips of the patient; and,
an LED object subassembly with which the patient interacts by manipulating the LED thimble with respect to the LED object.

2. The apparatus of claim 1, wherein the mechanical ground subassembly is constructed to match contours of the patient's distal extremity.

3. The apparatus of claim 2, wherein information from a 3D scan of the patient's distal extremity is used to match the mechanical ground subassembly to contours of the patient's distal extremity.

4. The apparatus of claim 1, wherein the mechanical ground subassembly further includes a securing component for binding the mechanical ground subassembly to the patient.

5. The apparatus of claim 1, wherein the distal effector subassembly further includes a securing component for binding the distal effector subassembly to the patient's wrist.

6. The apparatus of claim 1, wherein the distal effector subassembly further includes a securing component for binding the distal effector subassembly to the patient's ankle.

7. The apparatus of claim 1, wherein the finger extender subassembly further includes at least one distal effector link for disposition on the patient between the distal joints, and at least one distal effector link for disposition between proximal and distal joints.

8. The apparatus of claim 7, further including at least one flexible link for coupling the mechanical ground subassembly to the PIP finger link and for coupling the PIP finger link to one or more of the distal effector links.

9. The apparatus of claim 1, the mechanical ground subassembly and the distal effector subassembly being characterized by a subassembly neutral position and the patient's extremity being characterized by a patient neutral position, wherein the subassembly neutral position and the patient neutral position are substantially the same.

10. The apparatus of claim 7, wherein the mechanical ground subassembly and the distal effector subassembly resists movement away from the subassembly neutral position, and assists movement toward the subassembly neutral position.

11. The apparatus of claim 1, wherein the LED thimble includes at least one light source and at least one region having an electrically conductive surface.

12. The apparatus of claim 1, wherein the LED object includes at least one light source and at least one region having an electrically conductive surface.

13. The apparatus of claim 1, wherein the LED thimble and the LED object are electrically coupled to a computer system, wherein the computer system is capable of performing one or more of:
(a) providing signals to the LED thimble;
(b) providing signals to the LED object;
(c) receiving signals from the LED thimble;
(d) receiving signals from the LED object.

14. The apparatus of claim 1, further including one or more sensors for determining one or more of:
(a) force being applied with respect to any joint within the apparatus;
(b) angular position of any joint within the apparatus.

15. The apparatus of claim 1, wherein an electrically conductive surface on the LED thimble is capable of contacting an electrically conductive surface on the LED object, thereby closing an electrical circuit, the closing being detectable by a sensing circuit.
